(19) United States
(12) Patent Application Publication
(10) Pub. No.: US 2014/0214329 A1
(43) Pub. Date: Jul. 31, 2014

(54) SYSTEM AND METHOD FOR ANALYZING UNI- OR MULTI-VARIATE DATASETS

(71) Applicants: Vincent J. Hilser, Baltimore, MD (US); James O. Wrabl, Baltimore, MD (US); Omar Hadzipasic, Westwood, MA (US)

(72) Inventors: Vincent J. Hilser, Baltimore, MD (US); James O. Wrabl, Baltimore, MD (US); Omar Hadzipasic, Westwood, MA (US)

(21) Appl. No.: 13/752,025

(22) Filed: Jan. 28, 2013

(51) Int. Cl. G06F 19/18

(52) U.S. Cl. CPC G06F 19/18
USPC 702/19

(57) ABSTRACT

A system and method for analyzing a plurality of datasets acquired from a plurality of data sources includes identifying at least one descriptor common to the datasets. The method also includes using the at least one descriptor to calculate intra-data-source signed matrices and generating a similarity matrix based on the intra-data-source signed matrices. The method further includes analyzing an alignment of the data-sources using the similarity matrix and at least one analysis metric and generating a report indicating at least a similarity of the data sources.

### STATEMENT REGARDING FUNDING

This invention was made with government support under GM063747 awarded by the National Institutes of Health. The government has certain rights in the invention.

### BACKGROUND OF THE INVENTION

The present invention relates generally to systems and methods for signal processing. More specifically, the present invention relates to a system and method for dataset comparison.

Many penetrating insights into protein function and evolution have been inferred from analysis of amino acid sequences or comparison of three-dimensional atomic structures. For example, algorithms and analysis techniques have been developed to examine chemical structures and side chains. However, protein function and evolution arise from a manifold of physical, chemical, and biological mechanisms and, at best, can only be partly accounted for by side-chain identity or structure similarity. Consequently, proteins can and should be meaningfully characterized by other attributes, such as the energetic contributions to stability or the predicted codon translation efficiency along the mRNA. Such attributes are not easily accommodated by simple adaptation of current algorithms, largely because the scoring systems for such algorithms are based on positional sequence identity (amino acid substitution matrices) or absolute geometric structural similarity (Euclidean distance).

The resulting unfortunate situation is that properties other than sequence and structure, and their additional potential biological insight into proteins, have not been as thoroughly explored. For example, the local thermodynamic stability of a protein, as experimentally measured by deuterium-hydrogen exchange, is described by a one-dimensional sequence of numerical values (i.e. amide protection factors). These values are well-known to be a combination of sequence, structure, and solvent effects, but no substitution matrix or distance measure exists for the objective comparison of two sets of protection factors. Important knowledge might be missed due to the inability to make such comparisons. Worse, erroneous conclusions might be inferred from comparisons that separate the effects (for example, comparing side-chain identity in the absence of information about the thermodynamic stability at the same position).

It would therefore be desirable to provide a system and method for protein analysis that is not generally limited to side-chain identity or structure similarity.

### SUMMARY OF THE INVENTION

The present invention overcomes the aforementioned drawbacks by providing a system and method for protein analysis that considers non-vertical characteristics of datasets to generate reports regarding protein similarity. Specifically, the system and method considers horizontal information, such as secondary and tertiary characteristics to provide more accurate reports regarding protein similarity.

In accordance with one aspect of the invention, a method for analyzing a plurality of datasets acquired from corresponding sequences of proteins or genes is disclosed that includes identifying at least one descriptor common to the datasets and using the at least one descriptor for each protein or gene to calculate intra-sequence signed matrices. The method also includes generating a similarity matrix based on the intra-sequence signed matrices and analyzing an alignment of the sequences of proteins or genes using the similarity matrix and at least one analysis metric. The method also includes generating a report indicating at least a similarity of the proteins or genes.

In accordance with another aspect of the invention, a computer-readable storage medium, having stored thereon, a set of computer-executable instruction is disclosed. When the instructions are executed by a computer processor, the processor is caused to carry out the steps of receiving a plurality of datasets acquired from at least one of genes and proteins and identifying at least one dimension in the datasets and an common characteristic of the at least one of genes and proteins represented in the at least one dimension for analysis. The processor is further caused to carry out the steps of generating a signed distance matrix for each of the plurality of datasets with respect to the common characteristic represented in the at least one dimension, generating a similarity matrix based on the signed distance matrices, analyzing a similarity of the at least one of genes and proteins using the similarity matrix, and generating a report indicating at least a similarity of the at least one of genes and proteins.

In accordance with another aspect of the invention, a computer-readable storage medium, having stored thereon, a set of computer-executable instruction that, when executed by a computer processor, cause the processor to carry out a series of steps. The steps include receiving a plurality of datasets, identifying at least one characteristic aligned along a common dimension in the datasets and representing a varying set of numbers to consider, and generating a signed distance matrix for each of the plurality of datasets with respect to the at least one characteristic. The steps also include generating a similarity matrix based on the signed distance matrices, analyzing a similarity of the varying sets of numbers using the similarity matrix, and generating a report indicating at least a similarity of the varying sets of numbers.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a flow chart setting forth steps of an exemplary method and accompanying exemplary products of intermediate steps performed in accordance with a horizontal protein comparison tool (HePCaT) algorithm of the present invention.

FIG. 2A is a series of graphs of distributions of scores resulting from intermediate steps of FIG. 1 operating on exemplary parameters to illustrate the present utility of the present invention in applications such as investigating hydrophobicity, thermodynamic stability, and tAI value.

FIG. 2B is a pair of graphs of ν and σ² for probability distribution function (PDF) analyzed in accordance with the present invention and illustrating alignment significance relative to the applications addressed with respect to FIG. 2A.

FIG. 3 illustrates significant similarities in the human proteome to the Kyte-Doolittle hydropathy profile of adenosine receptor A2a.

FIG. 4 is a set of mammalian homologs that illustrate greater thermodynamic similarity to the human N-terminal domain of glucocorticoid receptor than do non-mammailian homologs.

FIG. 5 is a graph illustrating that translation efficiencies of homologous E. coli mRNA sequences do not appear to be conserved.

FIG. 6 is a graph illustrating that predicted remote homology between C. muridarum TC0624 and colicin pore-forming domain based on significant HePCaT similarity.

FIG. 7 is a schematic diagram illustrating an exemplary system configured to operate in accordance with the present invention.

### DETAILED DESCRIPTION OF THE INVENTION

As will be described in detail, the present invention provides a system and method for analyzing uni- or multi-variate datasets. That is, the present invention provides a system and method for processing, analyzing, and reporting regarding datasets having at least two dimensions, where one dimension (for example, the abscissa or horizontal dimension) is an arbitrarily monotonically increasing or decreasing variable represented by real numbers. The second and greater dimensions (for example, the ordinate or vertical dimension) may be represented by arbitrary real numbers that may exhibit arbitrary trends with respect to another dimension (for example, the abscissa). The invention accepts mathematical pre-processing of the data, such as window averaging, in either or both of the horizontal and vertical dimensions to emphasize numerical trends.

The present invention can be particularly useful, for example, in analyzing datasets where the dimension of the varying numbers represents the sequential integer amino acid positions along the chemical chain of protein residues. In this context, the present invention may be particularly useful, for example, in analyzing datasets where this second dimension may be, but is not necessarily limited to, hydrophobicity of an amino acid residue.

As another example, the present invention may be particularly useful, for example, in analyzing datasets where the dimension of the varying numbers represents time, such as increasing or decreasing, for example, in a given duration, such as months or years. In this context, the present invention may be particularly useful, for example, in analyzing datasets where this second dimension may be, but is not necessarily limited to, financial information.

One-dimensional software tools have been developed for the special case of hydrophobicity analysis, such as identification and alignment of the membrane spanning regions of non-globular proteins. While useful, these tools have historically incorporated family-specific scoring matrices and empirical gap penalties. Such heuristics hinder the algorithms' transferability to different proteins or applicability to data types other than transmembrane protein hydrophobicity. In addition, the scoring functions for hydrophobicity analysis are often based on absolute similarity, and while this is effective at finding matches that are similar in both shape and magnitude, two sets of data that describe the same shape, but are offset by a constant value, would be missed. For example, such a situation can arise for experimentally measured local thermodynamic stabilities of proteins, where the relative stabilities of the same structural region of two homologs are observed to be strikingly similar, yet offset by a constant ΔΔG value. Finally, some of these previous tools lack the capability for large database searches or do not include estimates of statistical significance, limiting their usefulness even for the appropriate input data.

The present invention provides a general tool to compare one-dimensional profiles defined by arbitrary sequences of numerical data. To maximize the flexibility of the tool, the invention can utilize two metrics that match both the relative shapes of the two profiles as well as the absolute similarity of the numerical values. Thus, a scoring system is designed to be independent of the input data type, and its utility is demonstrated on three diverse types of protein data normally not analyzable with a single software package. Because such a design emphasizes the closeness in shape of the two sets scanned over a horizontal range of positions, in contrast to the vertical position-by-position independent scoring of a standard amino acid substitution matrix, the algorithm is referred to herein as a horizontal protein comparison tool (HePCaT).

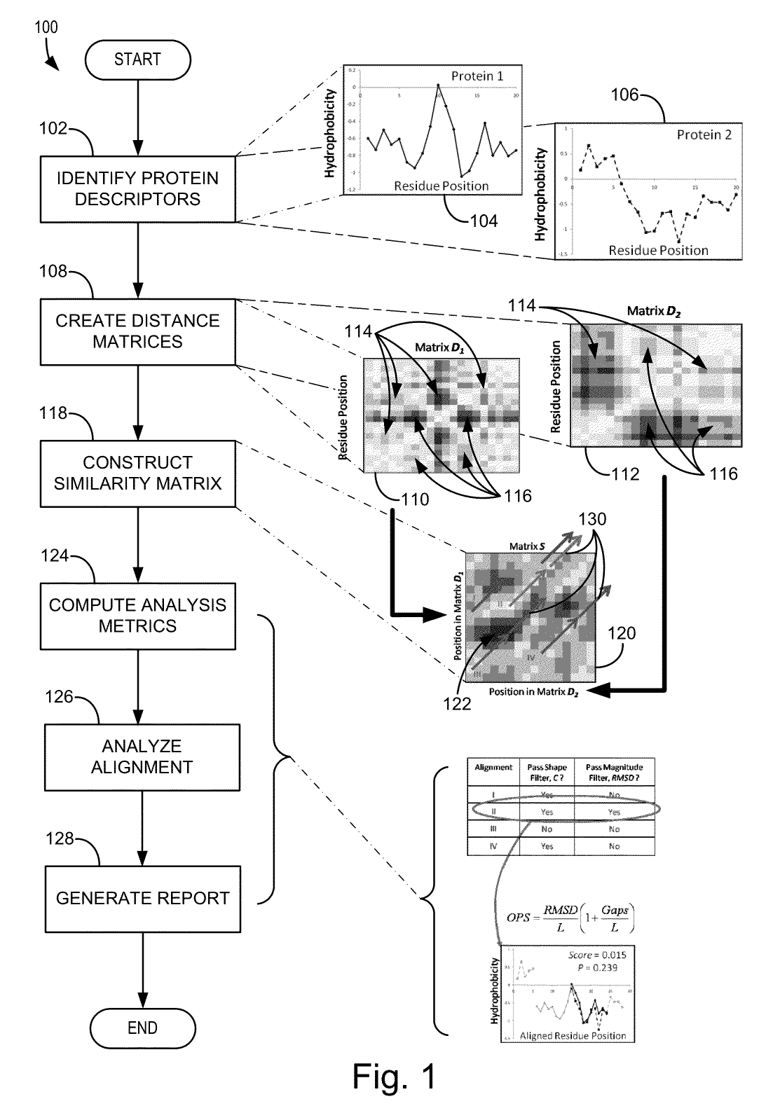

Referring to FIG. 1, an algorithm in accordance with the present invention 100 begins at process block 102 by identifying desired protein descriptor, such as position-specific protein descriptors. Exemplary data sets are illustrated in graphs 104, 106. Using this information, at process block 108, internal signed distance matrices are created from multiple sets (for example, each of two sets) of input numerical data vectors. For example, a for protein of M residues, each element of its distance matrix D may be defined as:

D_{i=1.M,j=1.M}=sign(νᵢ−νⱼ)\sqrt{(νᵢ−νⱼ)²} Eqn. 1.

The signed distance matrices, while not generally symmetric, are generally mirror images across the diagonal, such as illustrated in example matrices 110, 112. Thus, both shape and magnitude information about each data set are encoded in these matrices. For example, the Protein 2 matrix D2, as illustrated in graphic 112, clearly indicates the strong local maximum in the N-terminal half relative to the strong local minimum in the C-terminal half as prominent first regions 114 or second regions 116.

Equation 1 demonstrates a conceptual difference from structure comparison algorithms that are usually based on distance or contact matrices restricted to only positive values. This difference reflects the nature of the information being compared. For structure comparison, the distance between two atoms is identical whether it is computed between the first and second atom or vice versa, while in the case of thermodynamic stability, for example, there may be a relative stabilization between the first and second atoms which becomes a relative destabilization between second and first. The sign in eqn. 1, thus, represents this conceptual difference. That is, a distance in HePCaT has both sign and magnitude. It is noted that eqn. 1 may be generalized to an arbitrary number of dimensions.

At process block 118, shape similarity matrix, S, may then be constructed from the two matrices. A shape similarity matrix, for exemplary purposes only and created from example matrices 110, 112, is illustrated in matrix 120. To speed the calculation, a heuristic window size, W, may be introduced. In the present example, W is always five residues, but this is an adjustable parameter and a completely exhaustive search may be performed with W=1. For each position i=M−W−1 in Protein 1 and each position j=N−W−1 in Protein 2, the relative shape similarity is computed between the two five-residue blocks originating at positions i and j:

$${S}_{i = 1. M - W - 1 , j = 1. N - W - 1} = \frac{1}{W} {\sum }_{k = 0}^{W - 1} \vert {D}_{i i , j + k} - {D}_{2 j , j + k} \vert . \qquad Eqn . 2$$

In the above example, eqn. 2 represents the average absolute value of the difference of equivalenced internal distances between the two blocks. If the shape similarity is high, this value will be small. If the shape similarity is very different, this value will be large. Such dissimilarity can be readily viewed in matrix 120 as containing strong positive values (darkest areas 122) where the large peak in the middle of the first protein coincides with the deep valley in the C-terminal region of the second (or vice versa).

In this example, the signed internal distances within each block of W=5 residues are scaled such that the longest absolute value of the internal distance is one:

$${D}_{i , j + k} = \frac{{D}_{i , j + k}}{max ( abs ( {D}_{i , j + k} ) {\vert}_{k = 1}^{k = W} )} . \qquad Eqn . 3$$

Although this normalization can be disabled, emphasizing comparison of relative shape may, in at least some settings, improve detection of trends in biological data, which can exhibit wide variations in scale. Normalization also facilitates the choice of the user-defined alignment shape similarity cutoff, as described below.

At process block 124, analysis metrics are computed, which are then used at process block 126 to analyze the alignment and, ultimately, at process block 128, generate a report. As will be explained, the report may take various forms.

In this example, an “optimal” or desirable alignment between Proteins 1 and 2 may be found by exhaustive search of the shape similarity matrix 120. “Optimal” in this example may be regarded as the largest unique set of blocks of size W, subject to, at most, GapMax skipped positions of the similarity matrix between blocks that exhibit the smallest root mean square deviation (RMSD) of all such sets passing a user-defined shape similarity cutoff, C. If C=0, only exact shape matches are permitted in the alignment list. In this example, where eqn. 3 applies, C may be set to 0.40, meaning that an alignment whose average normalized distance between two five residue blocks was at most 40% different was counted as a matching shape. If eqn. 3 was foregone, C would be adjusted empirically based on the dynamic ranges of data compared.

In this example, the algorithm starts at cell (1,1) of S (that is, the lower left corner of the shape similarity matrix 120), corresponding to the average difference between the scaled intra-protein distances of residues 1-5 in Protein 1 and residues 1-5 in Protein 2. If S1,1≦C, this match is kept and position S6,6 is checked, until all cells of S are evaluated up to the position SM−W+1,N−W+1 (that is, the upper right corner of the shape similarity matrix 120). If, at any point, Si,j>C, single cell gaps may be inserted in one or both sequences up to a maximum of GapMax in an attempt to obtain the longest path through S subject to C.

A list of the longest gapped paths is determined and, in this example, is illustrated by way of the colored arrows 130 overlaid on the shape similarity matrix 120. Therefore, all paths in this list are comprised of equivalenced positions in the two proteins such that, on average, the intra-protein distances seen at every position match to at least degree C. This average value may be referred to as an average path distance (APD) and may be one metric calculated at process block 124. GapMax may be empirically selected, for example, as selected in the above example where it was set to 4. Generally, no penalty is applied to APD for insertion of a gap. At this first stage, only a relative shape similarity may be checked, such that any systematic offset between the two data sets is ignored because so that the differences between intra-protein distances are evaluated.

After the above search of the shape similarity matrix, the list of longest alignments passing the shape cutoff may be filtered by RMSD of the aligned residues. For example, the smallest RMSD alignment may be defined as the optimal, such that the RMSD operates as a magnitude filter. If multiple alignments of identical longest length happen to exhibit identical RMSD, only the first such one encountered may be returned. In accordance with one implementation of the present invention, the RMSD calculation is executed after translation of both sets to data to their respective centers-of-mass, thus effects of a global offset between each data set are again minimized. Following is Y, Dewey T G, Shindyalov I N, Bourne P E. 2004. A new scoring function and associated statistical significance for structure alignment by CE. J Comp Biol 11: 787-799, which is incorporated herein by reference in its entirety, an optimal path score (OPS) may be assigned to this optimal alignment according to the formula:

$$OPS = \frac{RMSD}{L} ( 1 + \frac{Gaps}{L} ) ; \qquad Eqn . 4$$

where L is the alignment length and Gaps is the total number of cells skipped in S to obtain that alignment. Note that gaps are not explicitly penalized during alignment, but gaps will penalize the final score according to eqn. 4, under the reasonable and common assumption that a gapless match is a “better” match than a gapped one. The GapMax parameter can be set to zero, if desired, so that all gaps are forbidden.

Probability models to estimate the significance of an OPS score “s” of an alignment of length L were derived from analysis of randomly generated alignments. It is important to note that these probability models are specific to the type of protein data aligned and must be recalibrated for a specific combination of W, C, and GapMax. More details about the probability models for three exemplary types of data are given below. Probability models for these data (Kyte-Doolittle hydropathy averaged over a 9-residue window, eScape predicted native state thermodynamic stability, and predicted translation efficiency index tAI (averaged over 9-residue window) were built for the following HePCaT parameters as listed in Supplementary Material: W=5 residues, GapMax=4 residues, and C=0.4 with the local scaling given in eqn. 3.

Construction of Probability Models

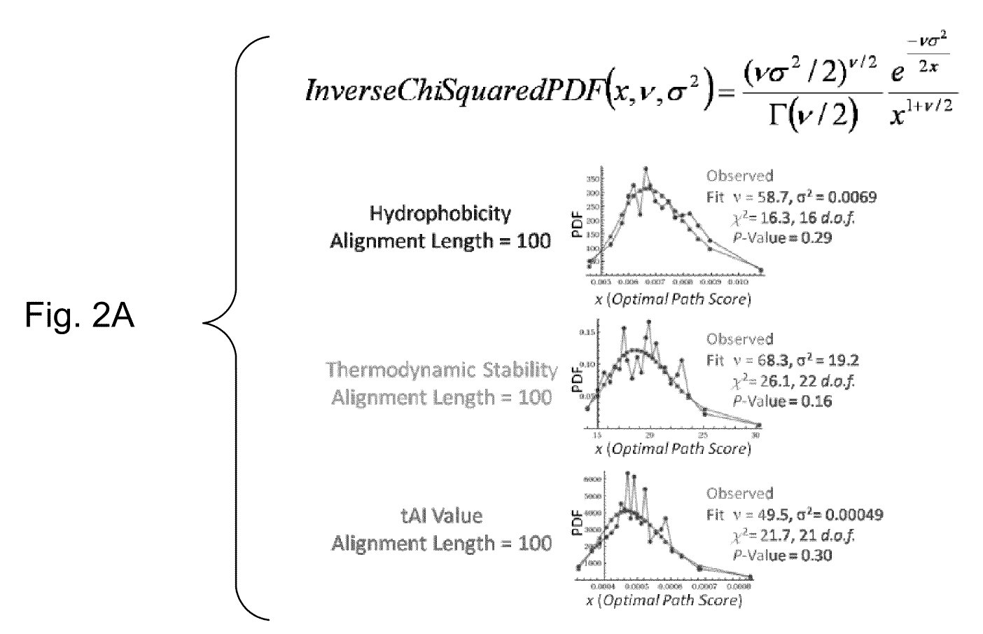

Significance of the eqn. 4 score of “optimal” HePCaT alignments was estimated with respect to random optimal alignments of identical length. Two random proteins of equal lengths between 10 and 500 residues were generated according to background amino acid frequencies. Sets of at least 20,000 such pairs were optimally aligned using HePCaT, and the distributions of eqn. 4 scores for a given optimal alignment length were tabulated, as illustrated in FIG. 2A.

Specifically, referring to FIG. 2A, distributions of eqn. 4 scores for HePCaT alignments of length L=100 were obtained from parameters W=5 residues, GapMax=4 residues, C=0.4. Random data was simulated for Kyte-Doolittle hydropathy averaged over a 9-residue window (“Hydrophobicity”), eScape predicted native state position-specific ΔG (“Thermodynamic Stability”) and predicted codon-specific mRNA translation efficiency (“tAI Value”). Binned data in each case was reasonably fit to the Inverse Chi-Squared probability distribution function (PDF).

It was observed that these skewed unimodal distributions exhibited a strong dependence on alignment length. Out of several possible two-variable formulae, it was empirically determined that these score distributions were statistically best fit by scaled inverse chi-square probability density functions, as indicated below using the following equation:

$${PDF}_{InverseChi - Squared} ( x ; v , {σ}^{2} \vert L ) = \frac{{( \frac{{σ}^{2} v}{2} )}^{\frac{2}{v}} {e}^{\frac{{σ}^{2} v}{2 x}}}{Γ ( \frac{v}{2} ) {x}^{1 + \frac{v}{2}}} ; \qquad eqn . 5$$

where L is optimal alignment length, and (x) is the Gamma function. Parameters and 2 were estimated by minimum chi-squared fits to the binned score data at each observed alignment length (FIG. 2A). Binning and parameter estimation were performed using custom Mathematica 8.0 scripts, such that each variable-width bin contained at least 20 points, additional details are provided in Supplementary Table 1. In Table 1, blank rows indicate that the null hypothesis (that the random distribution of OPS scores was drawn from an underlying inverse chi-square distribution) was rejected at the p<0.05 level.

TABLE 1

| | | | | | | |
|---|---|---|---|---|---|---|
| Alignment Length | v | ln σ² | l² | d.o.f. | p-Value | N |

“Hydrophobicity”
Kyte-Doolittle Hydropathy, averaged
Over 9 residues
W = 5 residues
GapMax = 4 residues
C = 0.4

| | | | | | | |
|---|---|---|---|---|---|---|
| 20 | 20.030 | −4.092 | 19.4 | 20 | 0.37 | 433 |
| 25 | | | | | | |
| 30 | 20.444 | −4.266 | 2.3 | 9 | 0.94 | 205 |
| 35 | 18.771 | −4.305 | 9.8 | 15 | 0.71 | 322 |
| 40 | 22.152 | −4.371 | 16.8 | 17 | 0.33 | 365 |
| 45 | | | | | | |
| 50 | 28.895 | −4.507 | 10.2 | 14 | 0.60 | 309 |
| 55 | 31.086 | −4.556 | 23.7 | 17 | 0.07 | 368 |
| 60 | 27.883 | −4.634 | 17.9 | 19 | 0.39 | 414 |
| 65 | 31.871 | −4.675 | 9.1 | 17 | 0.87 | 379 |
| 70 | 34.017 | −4.751 | 11.9 | 15 | 0.58 | 939 |
| 75 | 37.144 | −4.752 | 16.0 | 19 | 0.52 | 405 |
| 80 | 40.667 | −4.860 | 15.5 | 19 | 0.56 | 419 |
| 85 | 39.468 | −4.851 | 19.2 | 17 | 0.21 | 374 |
| 90 | 40.866 | −4.908 | 15.1 | 16 | 0.37 | 343 |
| 95 | 50.460 | −4.985 | 19.0 | 18 | 0.27 | 386 |
| 100 | 58.710 | −4.974 | 16.3 | 16 | 0.29 | 352 |
| 105 | 48.502 | −5.033 | 15.0 | 15 | 0.31 | 329 |
| 110 | 50.481 | −5.038 | 5.4 | 11 | 0.80 | 254 |
| 115 | 60.850 | −5.074 | 6.9 | 14 | 0.86 | 315 |
| 120 | 52.309 | −5.114 | 8.6 | 12 | 0.57 | 267 |
| 125 | 56.929 | −5.160 | 7.4 | 13 | 0.76 | 295 |
| 130 | 73.921 | −5.170 | 11.6 | 12 | 0.31 | 279 |
| 135 | 66.096 | −5.231 | 9.7 | 19 | 0.98 | 282 |
| 140 | 91.441 | −5.262 | 8.4 | 11 | 0.50 | 251 |
| 145 | 75.360 | −5.265 | 4.6 | 12 | 0.92 | 276 |
| 150 | 74.003 | −5.289 | 5.2 | 13 | 0.92 | 296 |
| 155 | | | | | | |
| 160 | 82.535 | −5.341 | 8.7 | 14 | 0.73 | 308 |
| 165 | 74.069 | −5.378 | 7.9 | 15 | 0.85 | 381 |
| 170 | 87.990 | −5.408 | 12.0 | 14 | 0.45 | 319 |
| 175 | 78.128 | −5.437 | 19.1 | 17 | 0.21 | 362 |
| 180 | 84.227 | −5.449 | 22.2 | 17 | 0.10 | 360 |
| 185 | 92.662 | −5.472 | 9.8 | 15 | 0.71 | 332 |
| 190 | 85.812 | −5.493 | 12.0 | 16 | 0.61 | 343 |
| 195 | 86.967 | −5.531 | 12.7 | 16 | 0.55 | 344 |
| 200 | 108.592 | −5.540 | 12.5 | 14 | 0.41 | 319 |
| 205 | 104.753 | −5.565 | 13.1 | 15 | 0.44 | 332 |
| 210 | 109.308 | −5.603 | 3.0 | 14 | 0.64 | 317 |
| 215 | | | | | | |
| 220 | 103.593 | −5.631 | 11.9 | 12 | 0.29 | 262 |
| 225 | 106.655 | −5.651 | 9.2 | 12 | 0.51 | 260 |
| 230 | 103.842 | −5.658 | 5.1 | 9 | 0.65 | 213 |
| 235 | 106.144 | −5.687 | 9.1 | 9 | 0.25 | 203 |
| 240 | 147.619 | −5.705 | 6.2 | 9 | 0.52 | 201 |
| 245 | 111.964 | −5.717 | 4.7 | 7 | 0.45 | 173 |

“Thermodynamic stability”
escape Native State ΔG Value
(cal/mol @ 25° C.)
W = 5 residues
GapMax = 4 residues
C = 0.4

| | | | | | | |
|---|---|---|---|---|---|---|
| 10 | 15.543 | 3.966 | 2.8 | 6 | 0.59 | 153 |
| 15 | 13.994 | 4.162 | 27.5 | 84 | 0.69 | 717 |
| 20 | 21.620 | 4.058 | 2.9 | 6 | 0.58 | 145 |
| 25 | 22.057 | 3.906 | 9.9 | 7 | 0.08 | 167 |
| 30 | 20.573 | 3.820 | 23.3 | 28 | 0.11 | 391 |
| 35 | 90.307 | 3.740 | 10.6 | 22 | 0.96 | 472 |
| 40 | 35.467 | 3.633 | 4.1 | 10 | 0.85 | 227 |
| 45 | 33.262 | 3.567 | 9.1 | 13 | 0.61 | 298 |
| 50 | 37.757 | 3.521 | 25.6 | 18 | 0.06 | 385 |
| 55 | 44.858 | 3.417 | 14.6 | 18 | 0.55 | 380 |
| 60 | 37.390 | 3.366 | 18.5 | 16 | 0.18 | 340 |
| 65 | 50.430 | 3.328 | 17.8 | 18 | 0.34 | 386 |
| 70 | 53.544 | 3.242 | 16.3 | 21 | 0.64 | 441 |
| 75 | 52.196 | 3.172 | 15.0 | 19 | 0.59 | 404 |
| 80 | | | | | | |
| 85 | 67.649 | 3.112 | 8.7 | 19 | 0.95 | 412 |
| 90 | 62.877 | 3.048 | 16.9 | 21 | 0.60 | 446 |
| 95 | 67.465 | 3.009 | 28.2 | 23 | 0.13 | 481 |
| 100 | 68.351 | 2.954 | 26.1 | 22 | 0.16 | 473 |
| 105 | 91.331 | 2.909 | 29.0 | 23 | 0.11 | 486 |
| 110 | 77.172 | 2.878 | 13.7 | 23 | 0.88 | 489 |
| 115 | 81.511 | 2.824 | 17.5 | 25 | 0.79 | 523 |
| 120 | 92.397 | 2.804 | 16.0 | 25 | 0.86 | 532 |
| 125 | 86.950 | 2.765 | 90.2 | 30 | 0.95 | 620 |
| 130 | 89.843 | 2.731 | 22.9 | 26 | 0.53 | 543 |
| 135 | | | | | | |
| 140 | 105.431 | 2.675 | 22.1 | 26 | 0.57 | 546 |
| 145 | 107.312 | 2.641 | 27.5 | 25 | 0.29 | 522 |
| 150 | 119.116 | 2.605 | 72.2 | 24 | 0.45 | 515 |
| 155 | 121.909 | 2.590 | 25.1 | 21 | 0.16 | 452 |
| 160 | 111.151 | 2.558 | 12.7 | 19 | 0.76 | 401 |
| 165 | 122.935 | 2.516 | 20.7 | 17 | 0.15 | 377 |
| 170 | 104.958 | 2.491 | 17.7 | 16 | 0.22 | 352 |
| 175 | 127.507 | 1.493 | 20.1 | 14 | 0.07 | 305 |
| 180 | 118.001 | 2.447 | 14.0 | 14 | 0.30 | 307 |
| 185 | 163.377 | 2.421 | 13.4 | 12 | 0.20 | 262 |
| 190 | 136.289 | 2.412 | 8.7 | 8 | 0.19 | 181 |
| 195 | 153.717 | 2.377 | 7.4 | 7 | 0.20 | 260 |

“Translation Efficiency”
E. coli tAI Value, averaged over 9
codons
W = 5 residues
GapMax = 4 residues
C = 0.4

| | | | | | | |
|---|---|---|---|---|---|---|
| 100 | 16.724 | −6.278 | 6.2 | 6 | 0.18 | 156 |
| 15 | 21.753 | −6.739 | 1.0 | 15 | 0.80 | 126 |
| 20 | 15.883 | −6.714 | 15.0 | 18 | 0.52 | 390 |
| 25 | 16.017 | −6.816 | 15.5 | 21 | 0.69 | 446 |
| 30 | 17.772 | −6.940 | 3.3 | 9 | 0.85 | 206 |
| 35 | 20.707 | −6.924 | 13.4 | 14 | 0.34 | 312 |
| 40 | 21.598 | −6.984 | 15.9 | 18 | 0.46 | 393 |
| 45 | 23.766 | −7.111 | 10.6 | 17 | 0.78 | 362 |
| 50 | 23.655 | −7.172 | 12.2 | 14 | 0.43 | 304 |
| 55 | 25.040 | −7.209 | 13.6 | 14 | 0.43 | 318 |
| 60 | 31.666 | −7.242 | 11.4 | 17 | 0.72 | 375 |
| 65 | 31.851 | −7.307 | 21.6 | 19 | 0.20 | 413 |
| 70 | 97.965 | −7.365 | 12.0 | 17 | 0.61 | 364 |
| 75 | 38.406 | −7.391 | 16.4 | 17 | 0.36 | 378 |
| 80 | 35.419 | −7.461 | 15.2 | 19 | 0.58 | 406 |
| 85 | 37.307 | −7.568 | 15.9 | 19 | 0.53 | 414 |
| 90 | 35.574 | −7.545 | 17.0 | 19 | 0.46 | 410 |
| 95 | 43.313 | −7.587 | 14.2 | 21 | 0.77 | 440 |
| 100 | 49.518 | −7.626 | 21.7 | 21 | 0.30 | 440 |
| 105 | 47.622 | −7.651 | 10.7 | 21 | 0.93 | 440 |
| 110 | 53.770 | −7.703 | 19.4 | 21 | 0.43 | 450 |
| 115 | 56.545 | −7.745 | 24.5 | 24 | 0.92 | 504 |
| 120 | 55.624 | −7.743 | 32.6 | 23 | 0.05 | 494 |
| 125 | 60.158 | −7.791 | 19.4 | 20 | 0.37 | 438 |
| 130 | 65.094 | −7.931 | 12.9 | 23 | 0.93 | 499 |
| 135 | 59.084 | −7.867 | 14.9 | 24 | 0.87 | 508 |
| 140 | 72.233 | −7.805 | 22.9 | 23 | 0.35 | 490 |
| 145 | 68.343 | −7.908 | 16.3 | 21 | 0.63 | 455 |
| 150 | 65.821 | −7.960 | 18.0 | 23 | 0.65 | 495 |
| 155 | 70.093 | −7.983 | 15.7 | 20 | 0.62 | 427 |
| 160 | 71.137 | −8.008 | 16.1 | 18 | 0.44 | 397 |
| 165 | 75.067 | −8.031 | 12.0 | 18 | 0.75 | 389 |
| 170 | 80.949 | −8.066 | 20.7 | 17 | 0.15 | 374 |
| 175 | 74.439 | −8.094 | 13.8 | 14 | 0.31 | 308 |
| 180 | 76.417 | −8.093 | 10.6 | 14 | 0.56 | 907 |
| 185 | 80.811 | −8.139 | 6.5 | 11 | 0.69 | 246 |
| 190 | 85.824 | −8.150 | 9.6 | 10 | 0.29 | 229 |
| 195 | 94.885 | −8.170 | 5.9 | 7 | 0.31 | 175 |
| 200 | 73.980 | −8.208 | 4.6 | 7 | 0.47 | 163 |

Ad-hoc analytical expressions can be fitted to the collected, best-fit parameters of eqn. 5 as a function of optimal alignment length L, such as illustrated in FIG. 2B, as follows:

ν(L|W,C,GapMax)=m(L) eqn. 6; and

σ²(L|W,C,GapMax)=e^{a+b ln(L+c)} eqn. 7;

where determination of coefficients a, b, c, and m only employed reasonably well-fit eqn. 5 values whose null hypotheses (that the simulated data were drawn from Inverse chi-square distributions) could not be rejected at p<0.05.

Specifically, referring to FIG. 2B, parameters ν and σ² for the PDF were observed to vary smoothly as a function of HePCaT alignment length, allowing the parameters, and thus alignment significance, to be analytically estimated for any alignment length using eqns. 6 and 7 and parameters in Table 1. Equations for displayed best-fit curves are as follows: y=0.497609x (Hydrophobicity, ν), y=0.740239x (Thermodynamic Stability, ν), y=0.455863x (E. coli tAI Value, ν), y=0.160379−1.04167 ln(x+38.9045) (Hydrophobicity, σ²), y=9.11826−1.23341 ln(x+45.3881) (Thermodynamic Stability, σ²), y=−2.96918−0.961557 ln(x+27.6082) (E. coli tAI Value, σ²).

Equations 6 and 7 coefficients for the various biological data sets used in this example are given in Table 2, all resulted from excellent fits of R2=0.99 or better using spreadsheet analysis.

TABLE 2

| Data Type | m | a | b | c |
|---|---|---|---|---|
| Hydrophobicity | 0.497609 | 0.160379 | −1.04167 | 38.9045 |
| Thermodynamic | 0.740239 | 9.11826 | −1.23341 | 45.3881 |
| Stability | | | | |
| E. coli tAl Value | 0.455869 | −2.96918 | −0.961557 | 27.6082 |

Therefore, given an observed optimal HePCaT alignment of length L with eqn. 4 score s, the probability p of observing that alignment by chance could be estimated from the corresponding scaled inverse chi-square cumulative distribution function as:

$$p ( s \vert L , W , C , GapMax ) = {\int }_{0}^{x < 5} {CDF}_{InverseChiSquared} ( x ; v ( L ) , {σ}^{2} ( L ) ) = {\int }_{0}^{x < 5} Q ( \frac{v}{2} , \frac{{σ}^{2} v}{2 x} ) ; \qquad eqn . 8$$

where Q(a,x) is the complement of the regularized Gamma function, as described in Press W H, Teukolsky S A, Vetterling W T, Flannery B P. 1992. Numerical recipes in C: the art of scientific computing. New York: Cambridge University Press, which is incorporated herein by reference in its entirety, and ν and σ² were estimated from eqns. 6 and 7, using coefficients specific to the particular biological data set under consideration.

Hydropathy Database Search of the Human Proteome Using Adenosine Receptor A2a as Query

The human proteome was obtained from translation of the DNA sequences contained in the NCBI CDDS (37) build 36.3 (Apr. 30, 2008). Each amino acid in every protein was assigned a side-chain hydrophobicity value according to the Kyte-Doolittle hydropathy scale. The values for each protein were averaged using a nine-residue sliding window; averaged values for the first and last four residues in each protein were subsequently ignored. The averaged values for human adenosine receptor A2a (CCDS 13826.1, gi|5921992) were used as query to the human proteome, that is, the averaged hydropathy values of each protein in the proteome were optimally pairwise aligned to A2a using HePCaT with the following parameters: W=5 residues, C=0.4, GapMax=4 residues. P-values for each alignment were computed using a probability model specific to these data (Table 1) and Table 2 parameters as described above. GPCRs were annotated in the human proteome by FASTA-aligning amino acid sequences of the proteome with amino acid sequences of known GPCRs obtained from the GPCRDB.

Pairwise Alignment of Disordered N-Terminal Glucocorticoid Receptor Domains Based on Predicted Stability

A BLAST (2) search of the NCBI nr database (Dec. 19, 2011, 16,645,108 sequences) with the full-length human glucocorticoid receptor protein (GR, gi|121069, 777 letters) as query was performed on the NCBI website using default parameters. 99 significant hits were returned. Clustering of the hits at 90% identity using cd-hit, such as described in Huang Y, Niu B, Gao Y, Fu L, Li W. 2010. CD-HIT suite: a web server for clustering and comparing biological sequences. Bioinformatics 26: 680-682, and incorporated herein by reference in its entirety, with otherwise default parameters and removal of one partially redundant GFP-chimera sequence resulted in 24 unique proteins. A multiple sequence alignment of these 24 proteins was computed using PROMALS3D, such as described in Pei J, Kim B H, Grishin N V. 2008. PROMALS3D: a tool for multiple protein sequence and structure alignments. Nucleic Acids Res 36: 2295-2300 and incorporated herein by reference in its entirety. The amino acid sequences of the N-terminal domains (NTD) of each protein indicated by this multiple alignment were separately extracted. Each N-terminal subsequence was input to the eScape software, such as described in Gu J, Hilser V J. 2008. Predicting the energetics of conformational fluctuations in proteins from sequence: a strategy for profiling the proteome. Structure 16: 1627-1637 and incorporated herein by reference in its entirety, a package that predicts native-state local thermodynamic stability (ΔG) of a protein under physiological conditions, based on amino acid sequence. The eScape stability profiles of each NTD were then each pairwise realigned to the human GR NTD using HePCaT with the following parameters: W=5 residues, C=0.4, GapMax=4 residues. P-values for each alignment were computed using a probability model specific to these data, Tables 1 and 2, parameters as described above.

Pairwise Alignment of Homologous E. Coli mRNA by Predicted Translation Efficiency tAI

Putatively homologous proteins of E. coli were extracted from the SCOP database v1.73 by first matching all annotations of organism (“Escherichia coli”) and then grouping non-redundant members by identical class, fold, superfamily, and family. To accurately map the SCOP amino acid sequence to the CSANDS database of mRNA, identical amino acid sequences, as aligned by FASTA between this initial set and the CSANDS database, were also manually inspected to ensure non-redundancy within families and retained for further analysis. The mRNA for each E. coli protein retained was obtained from the CSANDS database, and each mRNA codon of each sequence was assigned an estimated translation efficiency value, tAI, according to the values for E. coli given in Tuller T, Carmi A, Vestsigian K N, S., Dorfan Y, Zaborske J, et al. 2010. An evolutionarily conserved mechanism for controlling the efficiency of protein translation. Cell 14: 344-354 and incorporated herein by reference in its entirety. The tAI values for each mRNA were averaged using a nine-codon sliding window, averaged values for the first and last four codons in each protein were subsequently ignored. A total of 337 E. coli mRNAs from 128 SCOP families were ultimately analyzed. All pairs of mRNAs from putatively homologous proteins, 377 nonredundant pairs total, were pairwise aligned using HePCaT parameters of W=5 codons, C=0.4, GapMax=4 codons. P-values for each alignment were computed using a probability model specific to these data, Tables 1 and 2, parameters as described above. For comparison, Kyte-Doolittle hydropathy profiles were also constructed for these 337 proteins, the 377 pairs were pairwise aligned using HePCaT, and p-values specific to hydropathy were computed as described above for the human proteome.

Discovery of Similarity Between ORFan Protein TC0624 and Colicin Pore-Forming Domain

A dataset of 8812 ORFan protein sequences was obtained from Yomtovian I, Teerakulkittipong N, Lee B, Moult J, Unger R. 2010. Composiiton bias and the origin of ORFan genes. Bioinformatics 26: 996-999, which is incorporated herein by reference in its entirety. As described above, HePCaT was used to optimally align the Kyte-Doolittle averaged hydropathy profiles of each ORFan protein with the profile of each member of a non-redundant set of 214 membrane proteins of known structure derived from the ASTRAL domain database. These 214 proteins were the representatives resulting from a 70% sequence identity cd-hit (21) clustering of all membrane proteins (class f) in the SCOP 1.73 database. Secondary structure prediction was performed Hidden Markov Model sequence profile comparison was performed, both with default parameters.

Results

The utility of HePCaT was assessed by exploring three different biological questions: hydrophobicity similarity search against a database, pairwise alignment of local thermodynamic stability, and conservation of translation efficiency in E coli. Results described below provided biological insight from these common bioinformatics tasks, while simultaneously illuminating the strengths of the present invention in various different applications and environments.

Database Search Using Human Adenosine Receptor A2a as Query

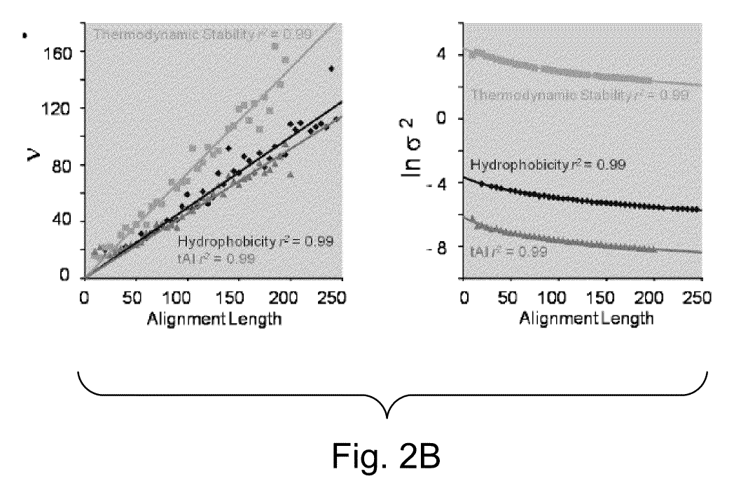

The hydropathy profile of the human adenosine A2a 7Tm G-protein coupled receptor (GPCR) was used to search the human proteome for close matches based solely on hydrophobicity patterns. As expected, hundreds of known 7Tm GPCRs were significantly matched by HePCaT (p<0.01, data not shown). The most significant ten matches are displayed in FIG. 3.

Specifically, referring to FIG. 3, pairwise HePCaT alignments are shown for A2a (black, gi|5921992) and the top nine most significant non-redundant hits in the human proteome. Lines 300 indicate known seven transmembrane proteins as annotated by the GPCR database, whereas lines 302 mostly indicate hits to the tail region of A2a. The hits are shown from top to bottom in order of most to least significance: hematological and neurological expressed protein-like 1 (gi|21700763, p=4.5×10⁻⁶), ephrin-A4 isoform a precursor (gi|4885197, p=8.3×10⁻⁵), NSFL1 cofactor p47 isoform a (gi|20149635, p=9.8×10⁻⁵), metallothionein-1E (gi|83367075, p=1.1×10⁻⁴), taste receptor type 2 member 19 (gi|28882035, p=4.4×10⁻⁴), B- and T-lymphocyte attenuator isoform 1 precursor (gi|145580621, p=5.7×10⁻⁴), WD-repeat domain-containing protein 83 (gi|153791298, p=6.8×10⁻⁴), dual specificity protein phosphatase 26 (gi|13128968, p=8.2×10⁻⁴), adenosine receptor A2b (gi|4501951, p=9.1×10⁻⁴). Thick lines indicate the optimal HePCaT alignment to A2a, and thin lines indicate unaligned positions.

Thus, these hits generally fell into two categories: those that matched the transmembrane region of A2a 300 and those that matched the tail region 302. The longest match to the transmembrane region was the A2b isoform, which is also 59% sequence identical to A2a. Unexpectedly, a Type 2 taste receptor also exhibited a significant match to this region. As this taste receptor has undetectable pairwise sequence identity to A2a and its structure has not been experimentally determined, this observed similarity may be a useful template for a homology model based on the A2a structure.

We attempted to rationalize the best matches to the A2a tail region in terms of sequence, structure, or function. However, in contrast to the transmembrane region matches, biological explanations for these remain mysterious. Some of the proteins in this group are medically important, such as the hematological and neurological expressed-1 like protein, ephrin A4 isoforms, and the B and T-lymphocyte attenuator precursor. Structural information about some of these hits could not be confidently transferred to the putatively disordered tail region of A2a, which is thought to be involved in ligand specificity of the GPCR. The shortest hit to the tail region was possibly a statistical artifact: this metallothionein is naturally short and contains a high frequency of cysteine residues; such low-complexity sequences are normally filtered out of amino acid sequence searches, which was not done in the present example.

Pairwise Alignment of Disordered N-Terminal Domains of Glucocorticoid Receptor

A second pilot study using HepCaT involved pairwise alignment of the disordered N-terminal domains (NTD) of protein sequences homologous to the human glucocorticoid receptor (GR). These nonredundant sequences, found by objective BLAST search, exhibited significant sequence identity over their entire lengths and came from mammals, amphibians, and fish. A state-of-the-art multiple alignment of the full-length sequences clearly demonstrated the weaker sequence similarity in the N-terminal regions relative to C-terminal regions, and the consequently lower confidence in the positional correctness of the N-terminal alignment. As the NTDs are known to mediate ligand specificity and biological activity of GR, we wished to use additional information about the estimated thermodynamic stability to possibly reveal important functional insights not obtainable from the less reliable sequence comparisons. The locally stable and unstable regions of each NTD could be represented as “peaks” and “valleys” and, like average hydrophobicity, were thus amenable to optimal pairwise comparison using HePCaT.

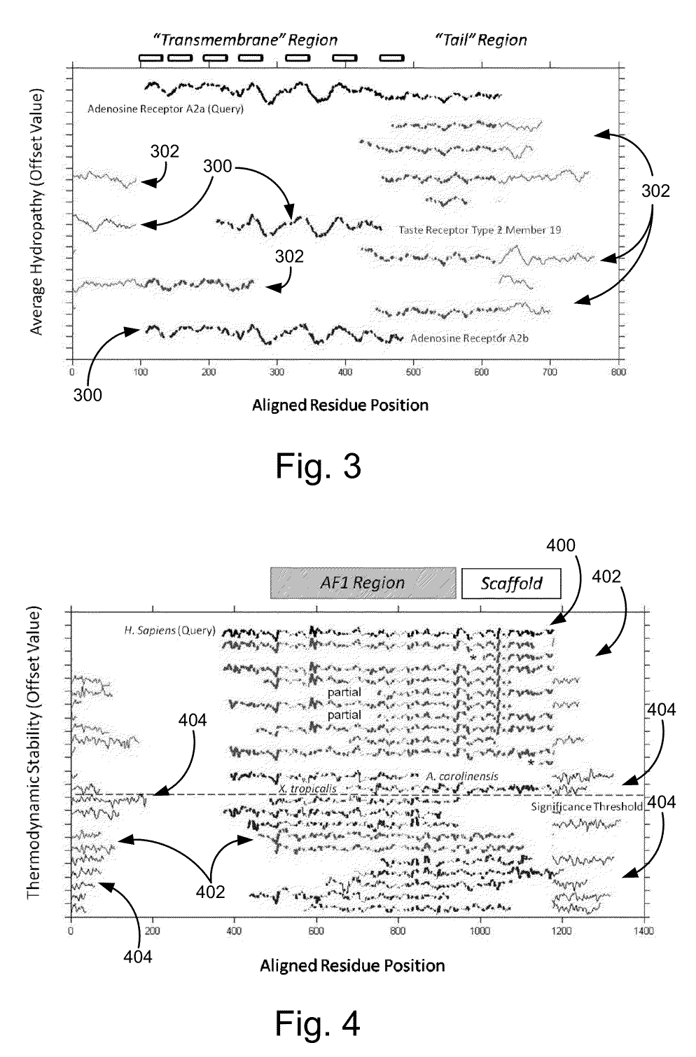

Each NTD stability dataset was separately aligned to the human NTD and significance of each comparison was computed as described above. These alignments are displayed in FIG. 4, arranged such that the most significant HePCaT comparisons are closer (top) to the human query and the least significant comparisons furthest away (bottom).

The human protein (gi|121069, residues 1-414) is illustrated at 400. Known AF1 and scaffold functional regions are indicated above. Pairwise aligned positions of other homologs are shown below the human protein, in order of estimated significance of the match: 1. H. sapiens (gi|239758, residues 1-394, p=0, exact match), 2. H. sapiens (gi|324021679, 1-99, p=0, exact match), 3. B. taurus (gi|74354555, 1-418, p=1.0×10⁻⁵¹), 4. R. norvegicus (gi|1189883, 1-433, p=0.33×10⁻³⁴), 5. S. labiatus (gi|121222567, 1-315, p=0.24×10⁻³⁰), 6. R. norvegicus (gi|152003264, 1-419, p=0.24×10⁻³⁰), 7. B. taurus (gi|38639409, 1-220, p=0.23×10⁻¹⁹), 8. R. norvegicus (gi|56325, 1-433, p=1×10⁻¹⁹), 9. O. cuniculus (gi|126723281, 1-409, p=1.8×10⁻¹¹), 10. O. anatinus (gi|149632435, 1-412, p=1.6×10⁻⁷), 11. H. sapiens (gi|221043882, 1-17, p=2.3×10⁻³), 12. A. carolinensis (gi|327285250, 1-410, p=2.8×10⁻³), 13. X. tropicalis (gi|62858859, 1-415, p=4.7×10⁻³), 14. C. carpro (gi|219936801, 1-382, p=2.1×10⁻²), 15. X. laevis (gi|147905167, 1-413, p=2.5×10⁻²), 16. O. latipes (gi|253314476, 1-416, p=0.10), 17. T. guttata (gi|224067332, 1-410, p=0.25), 18. M. domestica (gi|126290524, 1-414, p=0.38), 19. S. trutta (gi|57791246, 1-376, p=0.43), 20. P. promelas (gi|66737265, 1-380, p=0.55), 21. C. carpro (gi|156713894, 1-358, p=0.59), 22. C. pyrrhogaster (gi|319412066, 1-408, p=0.74), 23. D. rerio (gi|99028943, 1-382, p=0.82). The dashed line indicates a HePCaT significance threshold of p=0.01.

Thus, proteins from mammals are shown in lines 402 (generally above the significance threshold) and proteins from amphibians and fish are shown in lines 404 (generally below the significance threshold). As indicated, the A. carolinensis protein exhibits significant thermodynamic similarity in its AF1 region but not the scaffold region, while the X. tropicalis protein exhibits significant similarity in the scaffold region but less so in AF1. Annotated partial transcripts are labeled, and known human isoforms with alternative translation start sites are marked with asterisks. Thick lines indicate the optimal HePCaT alignment to the query, thin lines indicate unaligned regions.

Two important results were observed: first, NTDs from warm-blooded organisms 402 when compared to amphibians and fish 404 exhibited more significant thermodynamic similarity to the human NTD, and second, aligned regions of thermodynamic similarity generally often corresponded to one or more functionally relevant regions of the NTD, the so-called “AF1” and “scaffold” regions. These results suggest that NTD thermodynamic properties of mammals are significantly different than those of fish and amphibians. The functional interactions between isolated and intact human GR domains are currently under active study, and these predicted thermodynamic differences in the NTD may have biological implications. In particular, priority could be given to investigation of the isolated AF1 region of A. carolinensis and the scaffold region of X. tropicalis, as they seem to be the non-mammailian homologs with the most similar local stabilities to human.

Conservation of Predicted mRNA Translation Efficiency of Homologous E. coli Proteins

A third application of the HePCaT algorithm was to answer the question: Is the positional (codon-specific) translation speed of an mRNA conserved? To address this issue, more than 300 pairs of proteins highly similar in sequence and structure were extracted from the E. coli proteome according to the expert-curated classifications in the SCOP database. Crucially, proteins belonging to the same SCOP family are likely to be homologous, that is, descended from a common ancestor and thus, likely to be evolutionarily conserved. mRNA coding for each homologous protein was obtained from the CSANDS database and the predicted translation efficiency at each codon was computed according to the tAI values of Tuller, et al. These tAI values are thought to be a reasonable measure of translation speed through the ribosome at the codon level. The locally faster and slower regions along each mRNA could be represented as “peaks” and “valleys” and were thus amenable to optimal pairwise comparison using HePCaT.

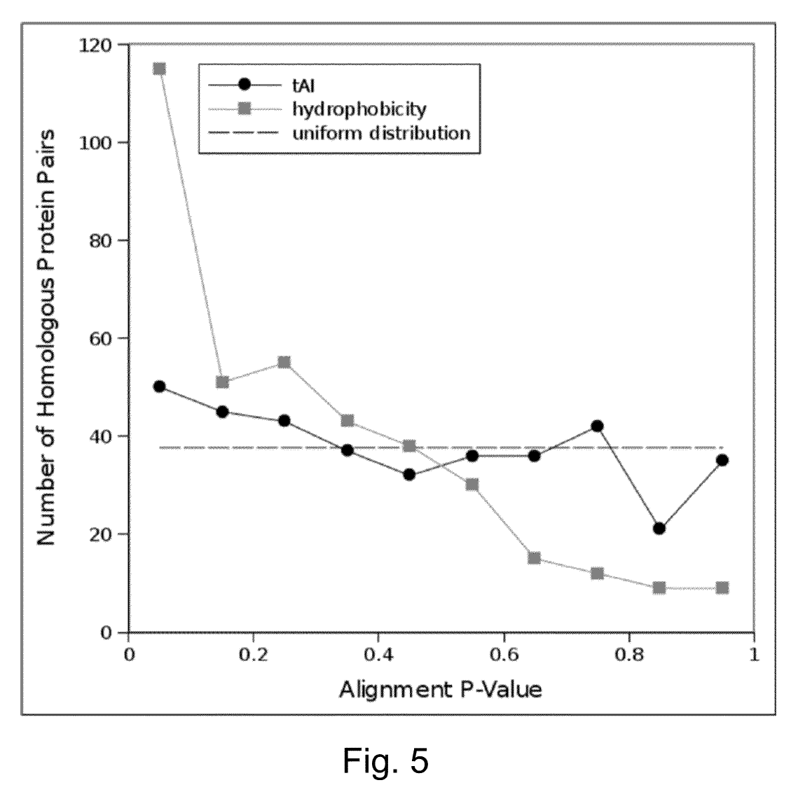

Each homologous protein pair's tAI values were aligned and significances computed. Referring to FIG. 5, the mRNA sequences of 377 pairs of E. coli proteins, each pair belonging to the same SCOP family, were optimally aligned using HepCaT based on the predicted translation efficiency tAI at each mRNA codon. The distribution of significance values for the set of optimal alignments is shown in dark circles; this distribution is not substantially different from a uniform distribution (dashed line). As a control, significances for the optimal alignments of Kyte-Doolittle hydropathy values for the same proteins exhibited a markedly skewed distribution (light squares), suggesting that hydrophobicity is more conserved than tAI for these proteins.

When the p-values for each alignment were tabulated, a surprising result emerged: p-values for translation efficiency were rather evenly distributed across all possible values between zero and one. This implied that, for most pairs of homologous mRNA, any similarities in translation efficiency were not significantly different from randomly uniform distribution. As a control, similarities in hydrophobicity for the same protein pairs showed a skewed distribution, with approximately one-third of all pairs exhibiting moderately significant similarity at p<0.10. Thus, it was concluded that position-specific translation efficiency, in contrast to hydrophobicity, sequence, or structure similarity, is not an evolutionarily conserved property of proteins.

Predicted Remote Homology Between the Pore Forming Domain of Colicin and Chlamydia TC0624 Protein

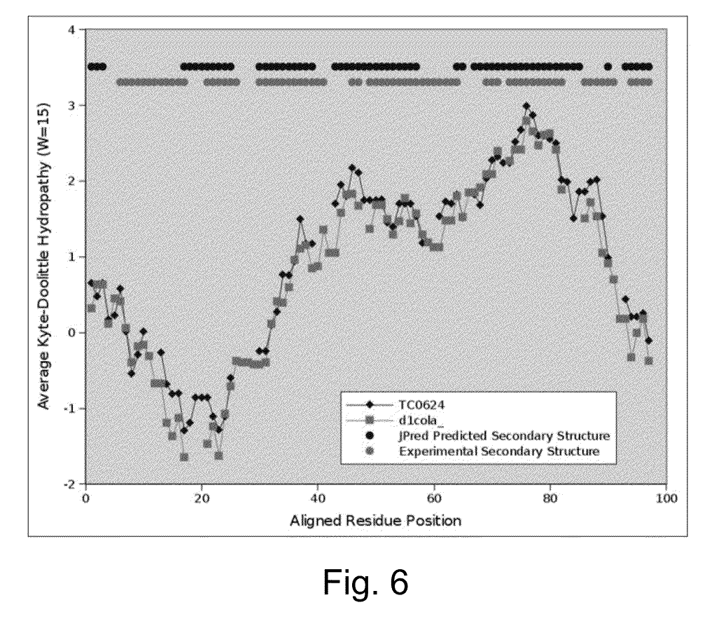

One additional example of the utility of HePCaT concerns the possible discovery of remote homology with medical importance. The C. muridarum protein TC0624, classified as an “ORFan” due to the absence of sequence similarity between any other known proteins, nonetheless exhibited a significant HePCaT hydropathy match to the pore forming domain of E. coli colicin A, such as illustrated in FIG. 6. Secondary structure prediction was consistent with tertiary structural similarity, as also illustrated in FIG. 6, and sensitive sequence search using Hidden Markov Models revealed marginal, but repeated, similarity to the sequence of colicin implicated in the hydropathy match. Thus, a total of four lines of evidence (hydropathy, secondary structure prediction, sequence similarity, and the regional correspondence between the sequence and structure matches) all converged on similarity between TC0624 and the pore forming domain of colicin. However, this conclusion would likely have not been possible without the original significance of the HePCaT hydropathy match.

Importantly, the hydrophobic region of colicin implicated in this match has long been thought to be functionally crucial for colicin's lethal ability to travel from a hydrophilic extracellular environment, insert into the hydrophobic membrane interior, and form toxic pores in its host. TC0624 has independently been placed in a class unique to Chlamydiae that is observed by experiment to also similarly partition into the membrane interior of the chlamydial inclusion. These so-called “Inc” proteins, difficult or impossible to predict using existing computational tools, are nonetheless important for chlamydial survival and maturation within its human and animal hosts. It appears that the extreme hydrophobicity exhibited by the inc proteins permits their computational prediction using HePCaT. A novel functional hypothesis for these medically important proteins is also suggested: the Incs may form membrane-spanning pores that obtain nutrition from the host cytoplasm. Finally, this example demonstrates that this “ORFan” may actually belong to a known protein family.

Discussion

Most protein and nucleic acid data contained within the avalanche of next-generation genome sequencing can be expressed as sequentially numeric “peaks” and “valleys”. These data include, but are not limited to, gene expression, ribosomal profiling, ChIP Seq, RNASeq, mRNA translation efficiency, thermodynamic stability of protein or mRNA, and physico-chemical properties such as hydrophobicity. A gap exists among traditional software algorithms for analysis of such data, and the HePCaT algorithm described herein is designed to help fill this gap.

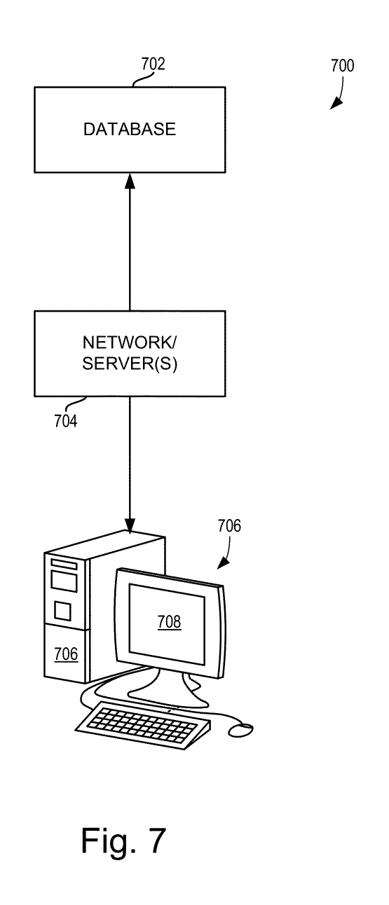

Referring to FIG. 7, the present invention can be incorporated into a computer system or a webtool that allows execution of the algorithm, visualization of the result, access to the raw and analyzed data. For example, a system 700 in accordance the present invention for implementing the methods, algorithms, and techniques described above may include one or more of a database, a network and/or server(s) 704, and a computer workstation 706. The computer workstation 706 includes a processor 706 configured to execute computer code stored on a non-transitive computer-readable storage medium to carry out the above-described methods, algorithms, and techniques. For example, raw data may be accessed from the database 702 and/or network/server(s) 704, processed at server(s) 704 or workstation 706, and a report generated, such as displayed on a display 708, of the workstation 706. It is noted that the system of FIG. 7 is simply exemplary and many other systems and variations are contemplated.

The present invention provides a variety of advantages not realized or possible using traditional systems or methods. For example, the input can be completely arbitrary. The algorithm is not limited to a particular type of data, any two sets of signed floating point numbers can be input. If the data can be expressed in numeric form regardless of its source, patterns can potentially be detected. The algorithm permits analysis of large data sets, for example entire genomes and proteomes. Also, the generalized scoring system of the present invention is sensitive to both shape and magnitude similarity, allowing some degree of pairwise alignment flexibility. The algorithm estimates statistical significance of the match. Furthermore, the W parameter emphasizes a horizontal matching of patterns, as contrasted with the vertical matching that commonly occurs with amino acid substitution matrices or profile PSSMs. The algorithm is mathematically generalizable to multiple dimensions.

Vertical evolutionary conservation of amino acids has been thoroughly explored using tools such as BLAST and FASTA, while horizontal conservation of other protein properties has not. Thus, non-local properties of proteins, depending on correlations across residue positions, such as thermodynamic stability, can now be potentially explored. Indeed, the finding presented, for example, in FIG. 4 of thermodynamic similarity between mammalian GR homologs could never have been detected using traditional amino acid sequence or structure-based analysis.

Rigorous evaluation of the statistical significance of a result is an essential piece of scientific data that is often neglected in bioinformatics tools. Indeed, the conclusions of the FIG. 5 results could not have been obtained without the associated statistical significance. As with other tools, the HePCaT statistical significances require calibration specific to the input data and algorithm parameters. Although recalibration for random simulation data not covered by Table 1 parameters is straightforward, an alternative estimate of statistical significance is available. Specifically, the non-parametric statistics of the MIC score reported by others can be used to evaluate a match returned by HePCaT. We believe that the applicability of the MIC statistics is maximized with HePCaT parameters of GapMax=0 and W=1.

Therefore, in summary, the present invention recognizes and utilizes at least three features of datasets advantageously. First, common trends between two sets of datasets that share data along a common dimension can be quantitatively identified. This is in contrast to current analysis tools that are largely limited to specific types of univariate abscissa and ordinate. Second, trends can be identified on the basis of both relative shape and absolute magnitude, in contrast to current analysis tools that require similar absolute magnitudes of ordinate. Third, the significance of the discovered trends can be quantitatively estimated, a result largely absent from current analysis tools. The present invention can integrate all three of these capabilities and, in doing so, the present invention can provide a variety of advantages not realized in traditional systems and methods.

The present invention has been described in terms of one or more preferred embodiments, and it should be appreciated that many equivalents, alternatives, variations, and modifications, aside from those expressly stated, are possible and within the scope of the invention.

1. A computer-readable storage medium, having stored thereon, a set of computer-executable instruction that, when executed by a computer processor, cause the processor to carry out the steps of:
receiving a plurality of datasets acquired from at least one of genes and proteins;
identifying at least one dimension in the datasets and an common characteristic of the at least one of genes and proteins represented in the at least one dimension for analysis;
generating a signed distance matrix for each of the plurality of datasets with respect to the common characteristic represented in the at least one dimension;
generating a similarity matrix based on the signed distance matrices;
analyzing a similarity of the at least one of genes and proteins using the similarity matrix; and
generating a report indicating at least a similarity of the at least one of genes and proteins.

2. The computer-readable storage medium of claim 1 wherein the common characteristic includes at least one of hydrophobicity profiles, thermodynamic stability, and tAI value.

3. The computer-readable storage medium of claim 1 wherein the processor is further caused to carry out the step of calculating an average path distance to analyze the similarity of the at least one of genes and proteins.

4. A method for analyzing a plurality of datasets acquired from corresponding sequences of at least one of proteins and genes, the method comprising:
identifying at least one descriptor common to the datasets;
using the at least one descriptor for each sequence of at least one of proteins and genes to calculate intra-sequence signed matrices;
generating a similarity matrix based on the intra-sequence signed matrices;
analyzing an alignment of the at least one of proteins and genes using the similarity matrix and at least one analysis metric; and
generating a report indicating at least a similarity of the at least one of proteins and genes.

5. The method of claim 4 wherein the at least one descriptor includes at least one of hydrophobicity profiles, thermodynamic stability, and tAI value.

6. The method of claim 4 wherein the intra-sequence signed matrix reflects a distance metric.

7. The method of claim 6 wherein the at least one analysis metric includes an average path distance of the distance metric.

8. The method of claim 7 further comprising applying a similarity cutoff when calculating the distance metric to exclude distance metrics outside the similarity cutoff from the average path distance of the distance metric.

9. The method of claim 8 wherein the similarity cutoff normalizes distances considered as a matching shape in the similarity matrix.

10. The method of claim 7 further comprising skipping positions of the similarity matrix that exhibit root mean square deviation (RMSD) outside a threshold of all such sets passing the similarity cutoff.

11. The method of claim 6 wherein the distance metric has both sign and magnitude components.

12. The method of claim 4 wherein the similarity matrix has a number of dimensions equal to the number of at least one of proteins and genes represented in the plurality of datasets.

13. The method of claim 4 wherein analyzing the alignment of the at least one of proteins and genes includes a calculating an optimal path score (OPS) relative to an optimal alignment of the at least one of proteins and genes, determined as
$$OPS = \frac{RMSD}{L} ( 1 + \frac{Gaps}{L} ) ,$$
where L is an alignment length and Gaps is a total number of cells skipped in similarity matrix to obtain a given alignment.

14. The method of claim 13 wherein the report includes the OPS and an applied probability model specific to at least the at least one of proteins and genes.

15. The method of claim 4 wherein the report includes a list of greatest gapped paths determined when analyzing the alignment of the at least one of proteins and genes.

16. A computer-readable storage medium, having stored thereon, a set of computer-executable instruction that, when executed by a computer processor, cause the processor to carry out the steps of:
receiving a plurality of datasets;
identifying at least one characteristic aligned along a common dimension in the datasets and representing a varying set of numbers to consider;
generating a signed distance matrix for each of the plurality of datasets with respect to the at least one characteristic;
generating a similarity matrix based on the signed distance matrices;
analyzing a similarity of the varying set of numbers using the similarity matrix; and
generating a report indicating at least a similarity of the varying set of numbers.

17. The computer-readable storage medium of claim 16 wherein the characteristic includes at least one of hydrophobicity profiles, thermodynamic stability, and tAI value.

18. The computer-readable storage medium of claim 16 wherein the processor is further caused to carry out the step of calculating an average path distance.

19. The computer-readable storage medium of claim 18 wherein the processor is further caused to carry out the step of applying a similarity cutoff to exclude values outside the similarity cutoff from a calculation of the average path distance.

20. The computer-readable storage medium of claim 19 wherein the processor is further caused to carry out the step of utilizing the similarity cutoff to normalize distances considered as a matching shape in the similarity matrix.

21. The computer-readable storage medium of claim 18 wherein the processor is further caused to carry out the step of skipping positions of the similarity matrix that exhibit root mean square deviation (RMSD) outside a threshold of all such sets passing the similarity cutoff.

22. The computer-readable storage medium of claim 16 wherein the processor is further caused to carry out the step of analyzing the alignment of the proteins by calculating an optimal path score (OPS) relative to an optimal alignment of the varying set of numbers, determined as
$$OPS = \frac{RMSD}{L} ( 1 + \frac{Gaps}{L} ) ,$$
where L is an alignment length and Gaps is a total number of cells skipped in similarity matrix to obtain a given alignment.

23. The computer-readable storage medium of claim 22 wherein the report includes the OPS and an applied probability model specific to at least the monotonically varying set of numbers.

24. The computer-readable storage medium of claim 16 wherein the varying set of numbers represents characteristics of at least one of proteins and genes.

25. The computer-readable storage medium of claim 16 wherein the varying set of numbers forms a monotonically varying set of numbers.

26. The computer-readable storage medium of claim 16 wherein the datasets include at least two dimensions, where the monotonically varying set of numbers is aligned along a first dimension of the at least two dimensions and a second of the at least two dimensions includes real numbers that represent trends with respect to the first dimension.
